(19) United States
(12) Patent Application Publication
(10) Pub. No.: US 2026/0329117 A1
(43) Pub. Date: Oct. 22, 2026

(54) PRIVACY DEVICE

(71) Applicant: Innolux Corporation, Miaoli County (TW)

(72) Inventor: Kazuto Jitsui, Miaoli County (TW)

(73) Assignee: Innolux Corporation, Miaoli County (TW)

(21) Appl. No.: 19/181,364

(22) Filed: Apr. 17, 2025

(51) Int. Cl. G02F 1/13; G02F 1/1333; G02F 1/1335; G02F 1/1337; G02F 1/1343

(52) U.S. Cl. CPC G02F 1/1323; G02F 1/133368; G02F 1/133528; G02F 1/1337; G02F 1/134363; G02F 1/13439

(57) ABSTRACT

A privacy device includes a share mode and a privacy mode. The privacy device includes a display panel and a switchable privacy panel overlapped with the display panel. The switchable privacy panel includes a first substrate, a second substrate, a first electrode, a second electrode, a third electrode and a liquid crystal layer. The second substrate is overlapped with the first substrate. The first electrode is disposed on the first substrate. The second electrode is disposed on the first substrate and adjacent to the first electrode. The third electrode is disposed on the second substrate. The liquid crystal layer is disposed between the first substrate and the second substrate. Under the share mode, a voltage difference is between the first electrode and the second electrode, and under the privacy mode, no voltage difference is between the first electrode and the second electrode.

### BACKGROUND

### Technical Field

This disclosure relates to an electronic device, in particular to a privacy device.

### Description of Related Art

The development of privacy devices has gradually matured, but display quality (e.g., viewing angle and/or brightness in share mode, etc.) of privacy devices still needs to be further improved.

### SUMMARY

The disclosure provides a privacy device with improved display quality.

In an embodiment of the disclosure, a privacy device includes a share mode and a privacy mode. The privacy device includes a display panel and a switchable privacy panel overlapped with the display panel. The switchable privacy panel includes a first substrate, a second substrate, a first electrode, a second electrode, a third electrode and a liquid crystal layer. The second substrate is overlapped with the first substrate. The first electrode is disposed on the first substrate. The second electrode is disposed on the first substrate and adjacent to the first electrode. The third electrode is disposed on the second substrate. The liquid crystal layer is disposed between the first substrate and the second substrate. Under the share mode, a voltage difference is between the first electrode and the second electrode, and under the privacy mode, no voltage difference is between the first electrode and the second electrode.

In an embodiment of the disclosure, a privacy device includes a share mode and a privacy mode. The privacy device includes a display panel and a switchable privacy panel overlapped with the display panel. In response to the privacy device being switched to the share mode, the switchable privacy panel is switched to a diffusion mode to diffuse incident light, and in response to the privacy device being switched to the privacy mode, the switchable privacy panel is switched to an absorption mode to absorb a portion of incident light.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1A and FIG. 1B are partial cross-sectional views of a privacy device under a share mode and a privacy mode according to some embodiments of the disclosure.

FIG. 2 is a partial top view of a light control film in a backlight module in FIG. 1A and FIG. 1B.

FIG. 3 is a partial cross-sectional view of a switchable privacy panel in FIG. 1A and FIG. 1B.

FIG. 4 to FIG. 8 are partial top views of five embodiments of the switchable privacy panel in FIG. 1A and FIG. 1B.

FIG. 9 is a partial top view of a first alignment layer and a second alignment layer in FIG. 3.

FIG. 10 is a partial top view of a first polarizer and a second polarizer in FIG. 3.

FIG. 11 is a partial top view of the switchable privacy panel in FIG. 3 under an initial state.

FIG. 12 and FIG. 13 are cross-sectional views corresponding to section lines X1-X1′ and Y1-Y1′ in FIG. 11.

FIG. 14 is a partial top view of the switchable privacy panel in FIG. 3 in response to the privacy device being switched to the share mode.

FIG. 15 to FIG. 17 are cross-sectional views corresponding to section lines X2-X2′, Y2a-Y2a′ and Y2b-Y2b′ in FIG. 14.

FIG. 18 is a partial top view of the switchable privacy panel in FIG. 3 in response to the privacy device being switched to the privacy mode.

FIG. 19 and FIG. 20 are cross-sectional views corresponding to section lines X3-X3′ and Y3-Y3′ in FIG. 18.

FIG. 21 and FIG. 22 are partial cross-sectional views of other embodiments of the switchable privacy panel in FIG. 1A and FIG. 1B.

FIG. 23 is a partial top view of another embodiment of the switchable privacy panel in FIG. 3 under an initial state.

FIG. 24 and FIG. 25 are cross-sectional views corresponding to section lines X1-X1′ and Y1-Y1′ in FIG. 23.

FIG. 26 is a partial top view of another embodiment of the switchable privacy panel in FIG. 3 in response to the privacy device being switched to the share mode.

FIG. 27 to FIG. 29 are cross-sectional views corresponding to section lines X2-X2′, Y2a-Y2a′ and Y2b-Y2b′ in FIG. 26.

FIG. 30 is a partial top view of another embodiment of the switchable privacy panel in FIG. 3 in response to the privacy device being switched to the privacy mode.

FIG. 31 and FIG. 32 are cross-sectional views corresponding to section lines X3-X3′ and Y3-Y3′ in FIG. 30.

FIG. 33 is a partial cross-sectional view of another embodiment of the switchable privacy panel in FIG. 1A and FIG. 1B.

FIG. 34 is a partial top view of a first polarizer and a second polarizer in FIG. 33.

FIG. 35 is a partial top view of the switchable privacy panel in FIG. 33 under an initial state.

FIG. 36 and FIG. 37 are cross-sectional views corresponding to section lines X1-X1′ and Y1-Y1′ in FIG. 35.

FIG. 38 is a partial top view of the switchable privacy panel in FIG. 33 in response to the privacy device being switched to the share mode.

FIG. 39 to FIG. 41 are cross-sectional views corresponding to section lines X2-X2′, Y2a-Y2a′ and Y2b-Y2b′ in FIG. 38.

FIG. 42 is a partial top view of another embodiment of the switchable privacy panel in FIG. 33 in response to the privacy device being switched to the privacy mode.

FIG. 43 and FIG. 44 are cross-sectional views corresponding to section lines X3-X3′ and Y3-Y3′ in FIG. 42.

FIG. 45 and FIG. 46 are partial cross-sectional views of other embodiments of the switchable privacy panel in FIG. 1A and FIG. 1B.

### DESCRIPTION OF THE EMBODIMENTS

Reference will now be made in detail to the exemplary embodiments of the disclosure, examples of which are illustrated in the accompanying drawings. Whenever possible, the same reference numerals are used in the drawings and descriptions to refer to the same or similar parts.

Throughout this specification and the claims, certain words are used to refer to specific components. One of ordinary skill in the art will appreciate that manufacturers of electronic devices may refer to the same component by different names. This disclosure is not intended to differentiate between components that have the same function but have different names. In the following description and claims, the words “include” and “comprise” are open-ended terms and should therefore be interpreted to mean “includes, but is not limited to . . . ”.

The directional terms mentioned in this disclosure, such as “up”, “down”, “front”, “back”, “left”, “right”, etc., are only for reference to the directions in the accompanying drawings. Accordingly, the directional terms used are illustrative and not limiting of the disclosure. In the drawings, each figure illustrates the general features of methods, structures, and/or materials used in particular embodiments. However, these drawings should not be interpreted as defining or limiting the scope or nature encompassed by these embodiments. For example, the relative sizes, thicknesses, and locations of various layers, regions, and/or structures may be reduced or exaggerated for clarity.

One structure (or layer, component, substrate) described in the disclosure is located on/above another structure (or layer, component, substrate), which may mean that the two structures are adjacent to each other and are directly connected, or that the two structures are adjacent to each other and are not directly connected. Non-directly connected means that there is at least one intermediary structure (or intermediary layer, intermediary component, intermediary substrate, intermediary spacer) between the two structures, with the lower surface of one structure adjacent to or directly connected to the upper surface of the intermediary structure, and the upper surface of the other structure adjacent to or directly connected to the lower surface of the intermediary structure. The intermediary structure may be a single or multi-layered solid or non-solid structure, without limitation. In the disclosure, when a structure is disposed “on” other structures, it may mean that a structure is “directly” on the other structures, or that a structure is “indirectly” on the other structures, that is, a structure and other structures have at least one other structure sandwiched between them.

The terms “approximately”, “substantially” or “generally” are generally interpreted as being within 10% of the given value or range, or within 5%, 3%, 2%, 1% or 0.5% of the given value or range. In addition, the terms “the range is from the first value to the second value”, “the range is between the first value and the second value” indicate that the range includes the first value, the second value, and other values in between.

The ordinal numbers used in the specification and claims, such as “first” and “second”, are used to qualify the components, and do not in themselves imply or represent any previous ordinal number of the component or components, nor do they represent the order of one component or component with another, or the order of the manufacturing method. The use of these numbers is intended only to enable a component with a certain designation to be clearly distinguished from another component with the same designation. The same terminology may not be used in the claims and the specification. Accordingly, the first component in the specification may be the second component in the claims.

The electrical connection or coupling described in the disclosure may refer to either a direct connection or an indirect connection, in which the terminals of the two circuit elements are directly connected or connected to each other by a conductor line, or an indirect connection in which the terminals of the two circuit elements are connected by a switch, a diode, a capacitor, an inductor, a resistor, or any other suitable component, or a combination of the foregoing, without limitation.

In this disclosure, the thickness, length, and width can be measured by using an optical microscope (OM), and the thickness or width can be measured by cross-sectional images in an electron microscope, but not limited thereto. In addition, there may be a certain amount of error between any two values or directions used for comparison. Furthermore, the expression “the given range is the first value to the second value”, “the given range falls within the range of the first value to the second value” or “the given range is between the first value to the second value” means that the given range includes the first value, the second value, and other values in between. If the first direction is perpendicular to the second direction, the angle between the first direction and the second direction can be between 80 degrees and 100 degrees; if the first direction is parallel to the second direction, the angle between the first direction and the second direction can be between 0 degrees and 10 degrees.

Unless otherwise defined, all terms used herein, including technical and scientific terms, have the same meanings as are commonly understood by those skilled in the art. It is to be understood that these terms, such as those defined in commonly used dictionaries, should be interpreted as having a meaning consistent with the context or background of the relevant technology and the present disclosure, and should not be interpreted in an idealized or overly formalized manner, except as specifically defined in the embodiments of the present disclosure.

In the disclosure, the electronic device may include a display device, a backlight device, an antenna device, a packaging device, a sensing device, or a splicing device, but not limited thereto. The electronic device may be a bendable or flexible electronic device. The display device can be a non-self-illuminating display device or a self-illuminating display device. The display device may include, for example, liquid crystal, light-emitting diode, fluorescence, phosphor, quantum dot (QD), other suitable display media, or a combination of the above. The antenna device may include, for example, a reconfigurable intelligent surface (RIS), a frequency selective surface (FSS), a radio frequency filter (RF-Filter), a polarizer, a resonator, or an antenna. (Antenna) et al. The antenna may be a liquid crystal antenna or a varactor diode antenna. The sensing device may be a sensing device that senses capacitance, light, heat energy, or ultrasonic waves, but not limited thereto. In the disclosure, the electronic device may include electronic components, and the electronic components may include passive components and active components, such as capacitors, resistors, inductors, diodes, transistors. Diodes may include light-emitting diodes, varactor diodes, or photodiodes. The light-emitting diode may include, for example, an organic light-emitting diode (OLED), a sub-millimeter light-emitting diode (mini-LED), a micro light-emitting diode (micro-LED), or a quantum dot light-emitting diode (quantum dot LED), but not limited thereto. The splicing device may be, for example, a display splicing device or an antenna splicing device, but not limited thereto. It should be noted that the electronic device can be any combination of the above, but not limited thereto. The packaging device may be suitable for Wafer-Level Package (WLP) technology or Panel-Level Package (PLP) technology, such as chip first or RDL first process. In addition, the shape of the electronic device may be a rectangular shape, a circular shape, a polygonal shape, a shape with curved edges, or other suitable shapes. Electronic devices may have peripheral systems such as drive systems, control systems, and light source systems to support display devices, antenna devices, wearable devices (e.g., including augmented reality or virtual reality), vehicle-mounted devices (e.g., including car windshields), or splicing devices.

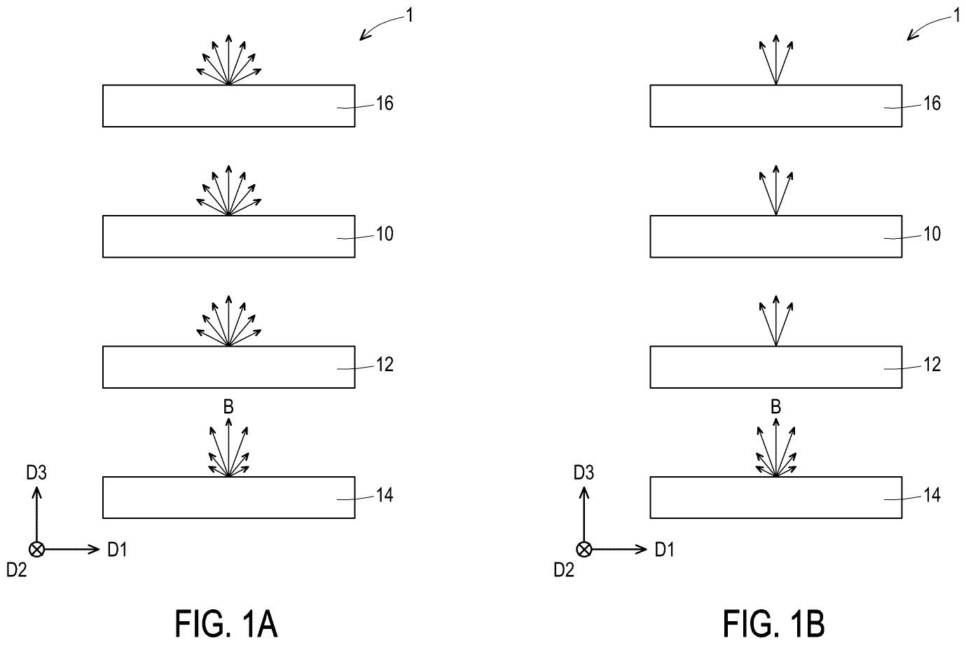

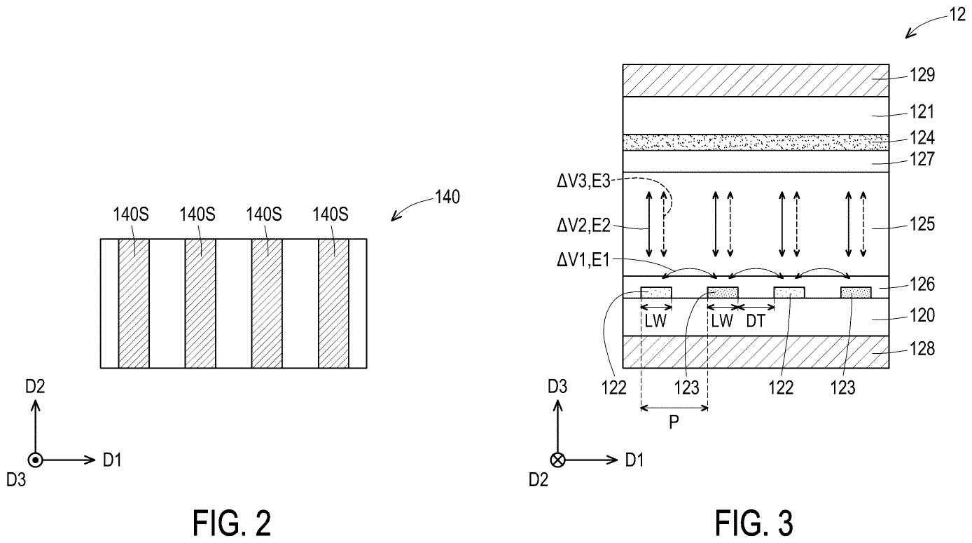

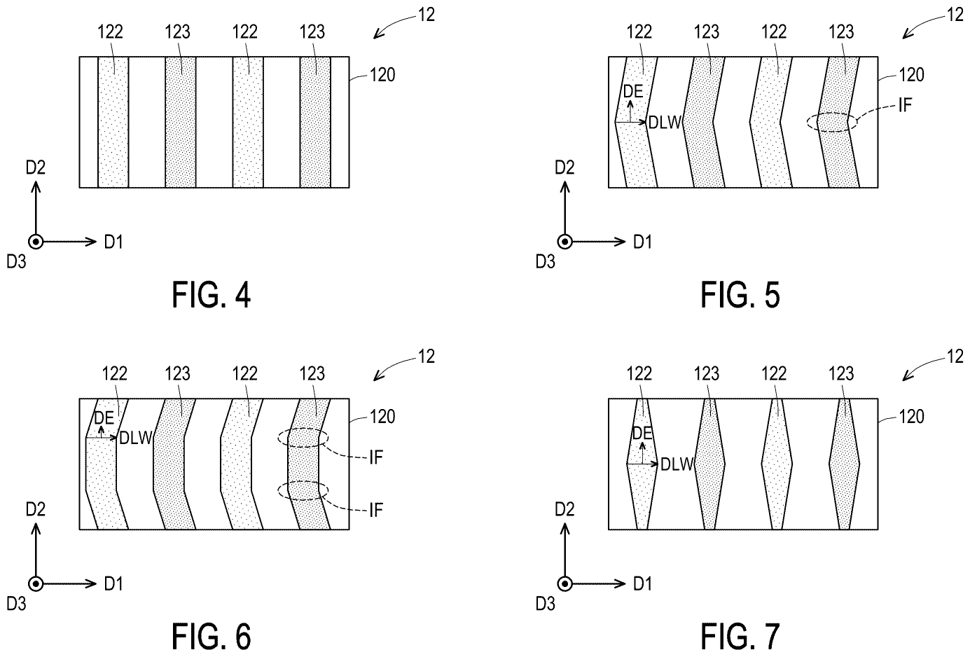

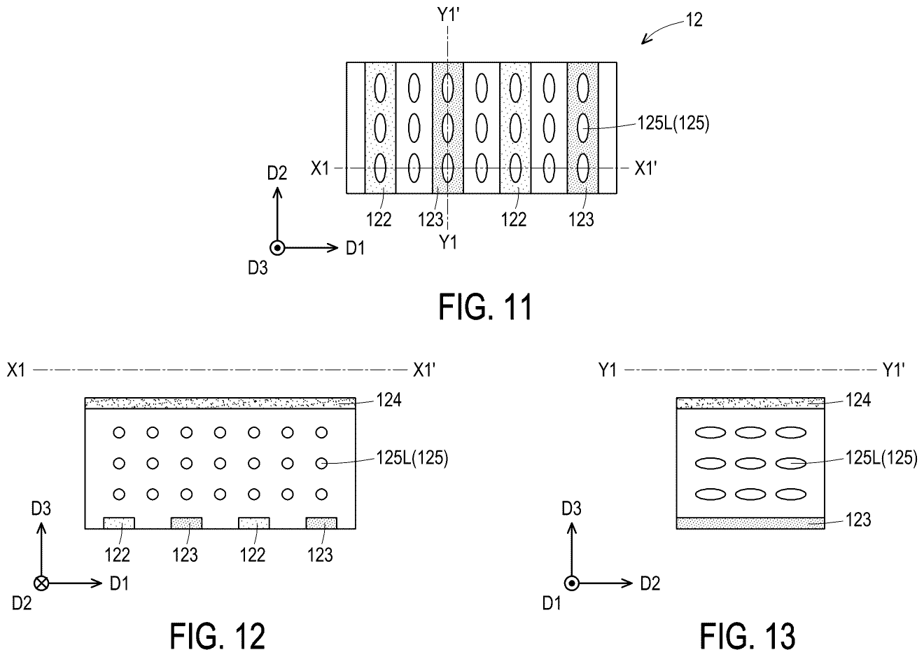

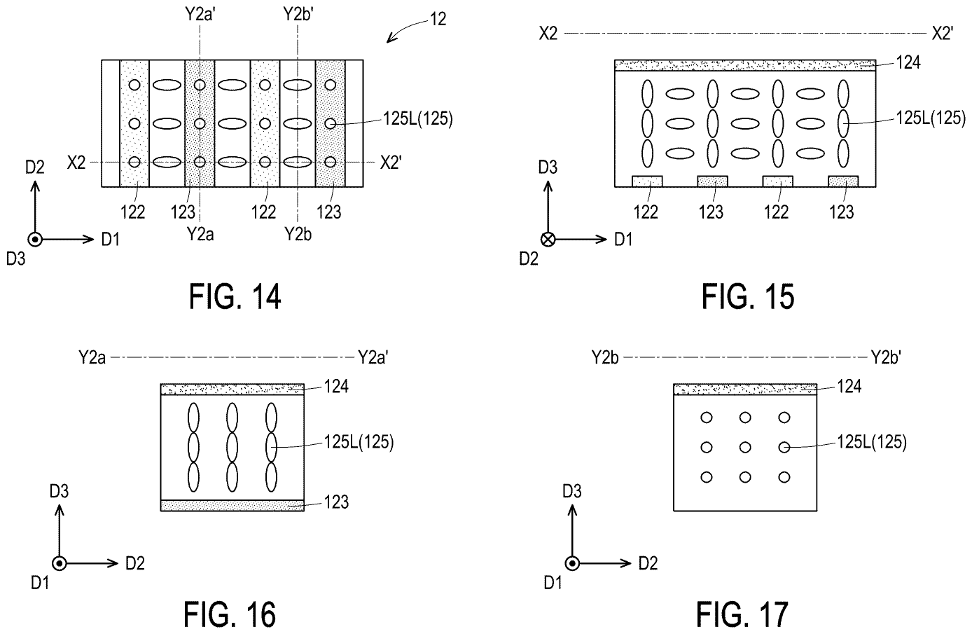

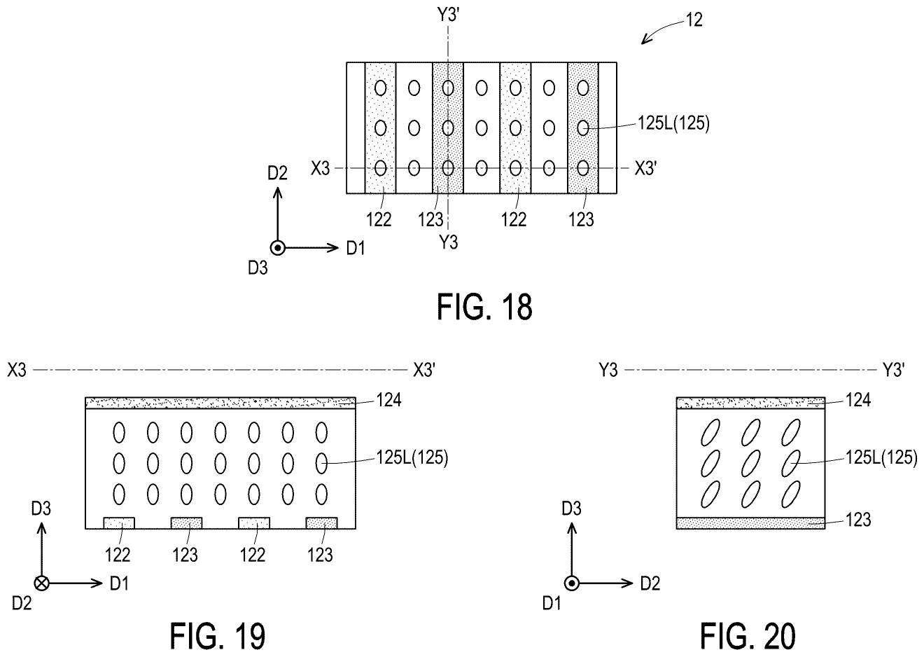

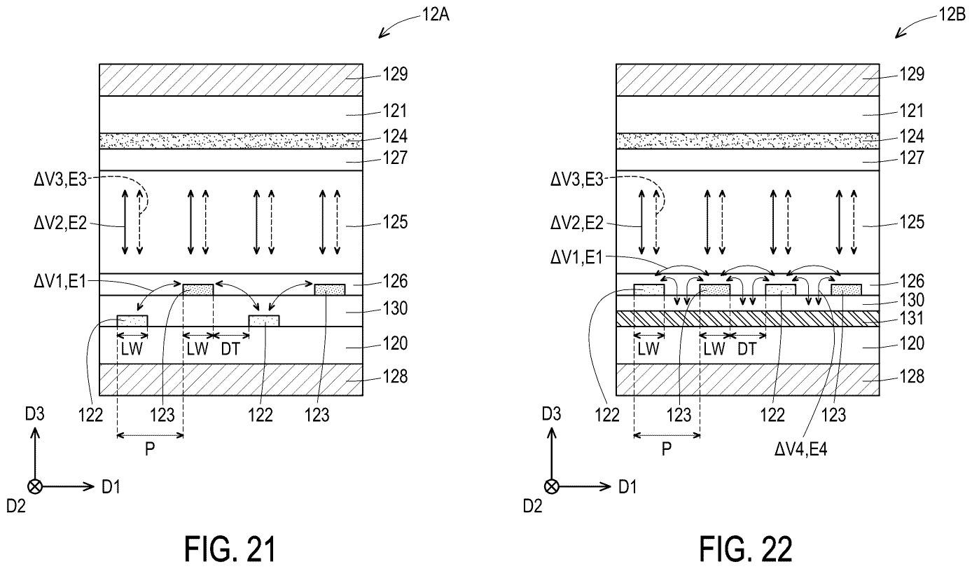

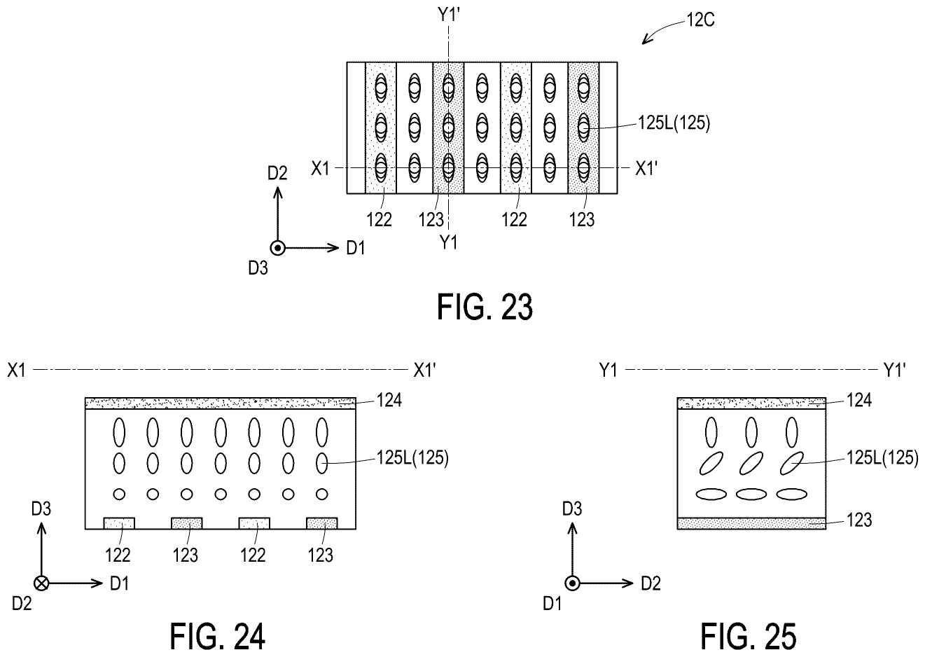

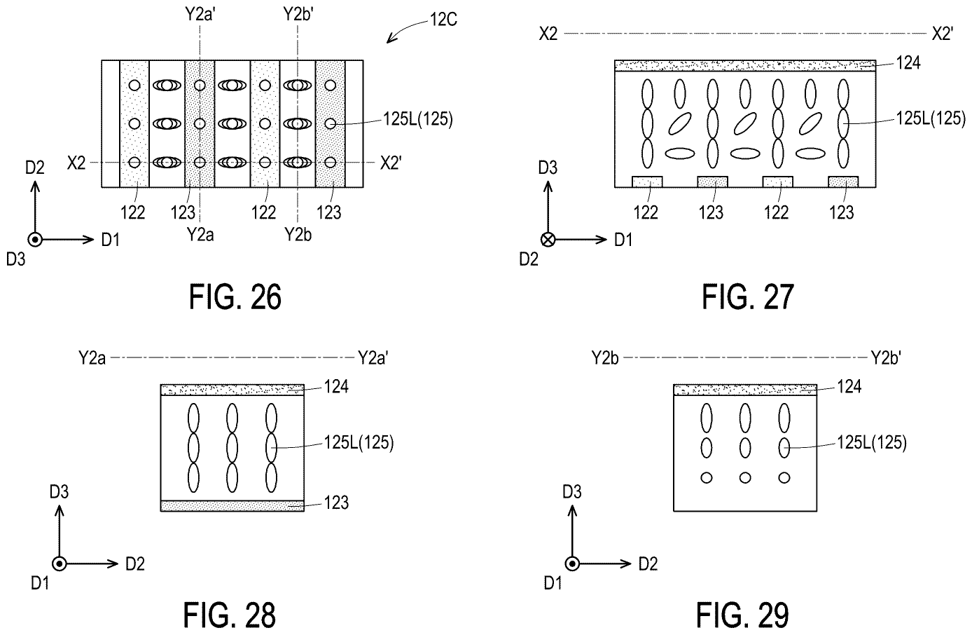

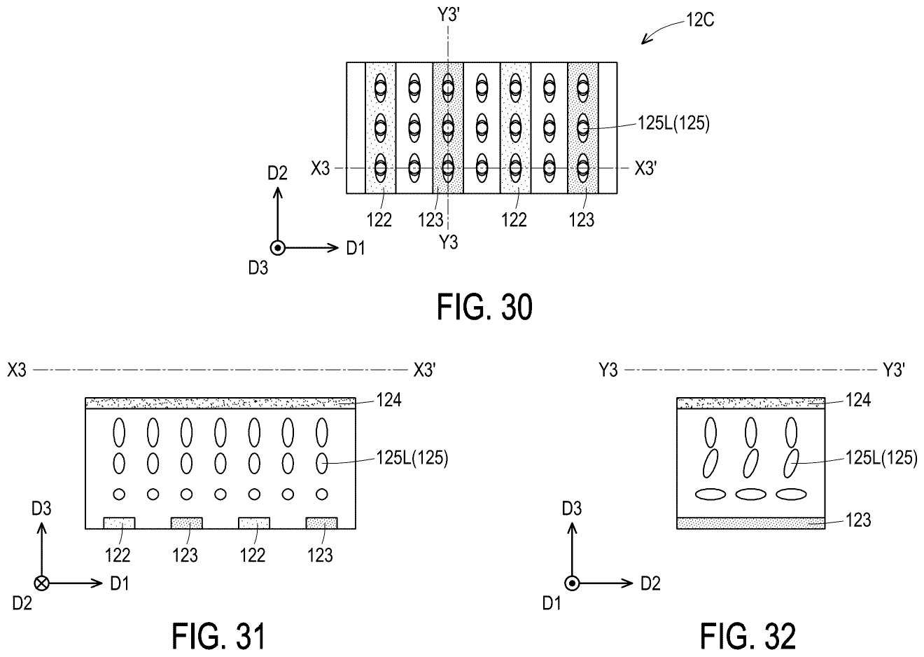

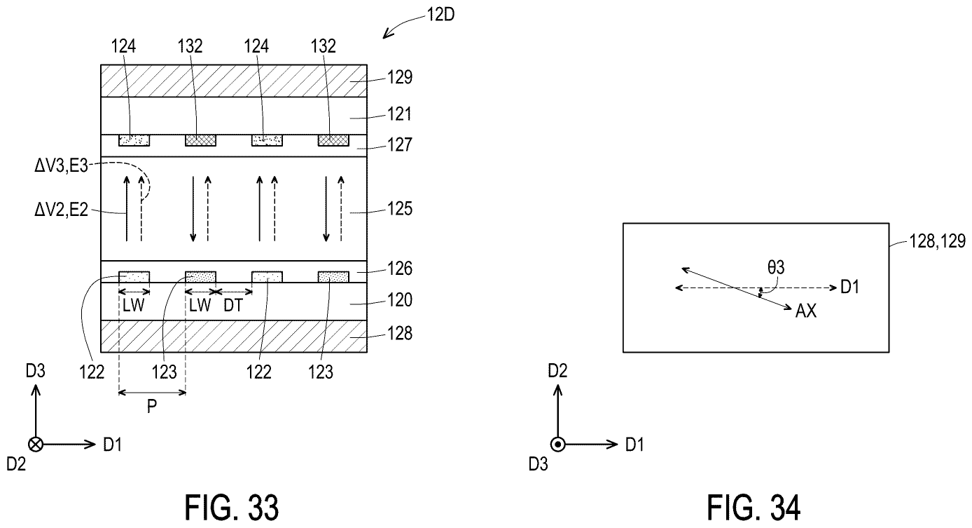

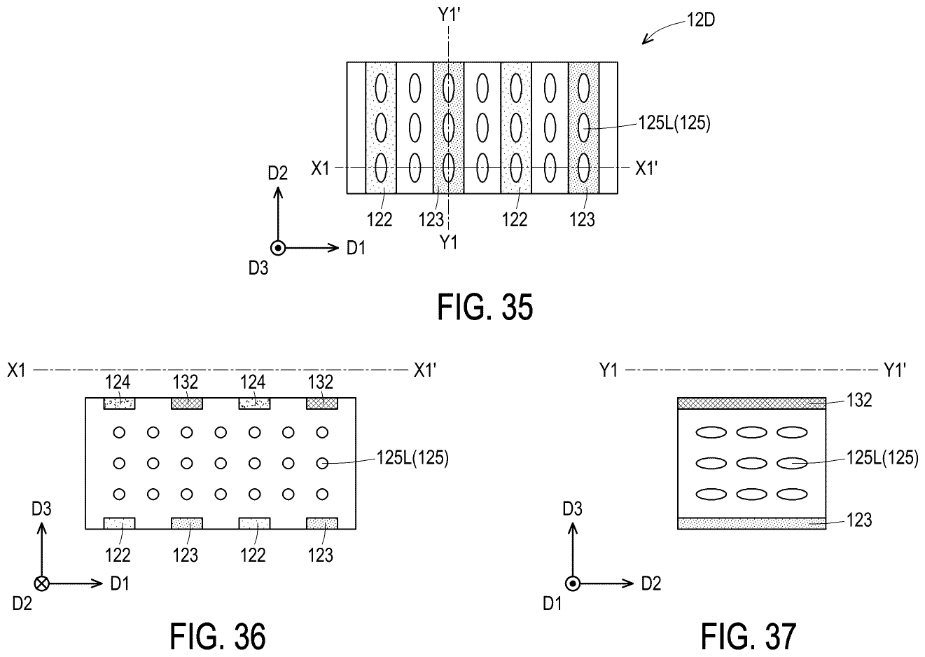

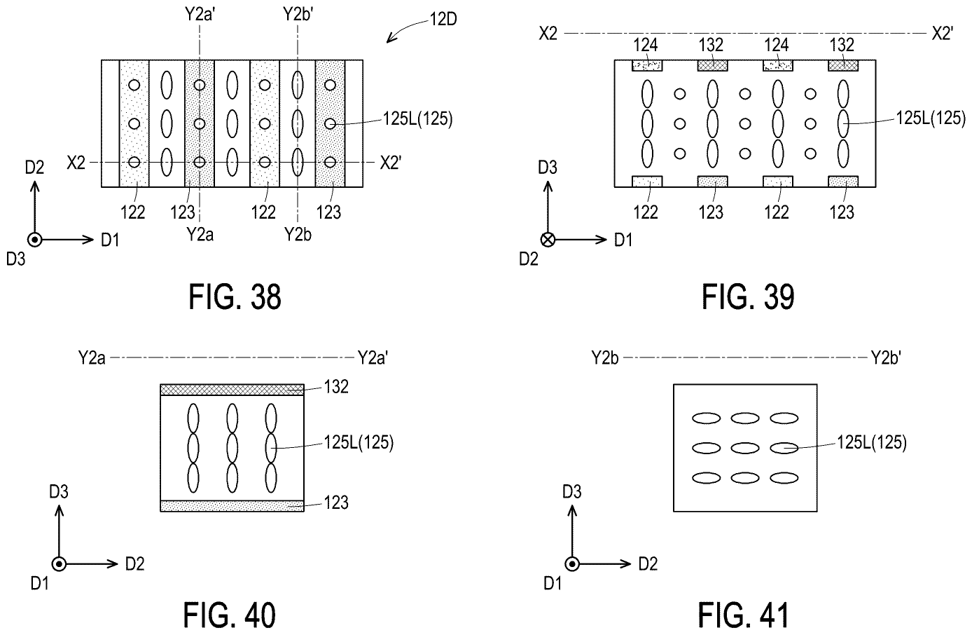

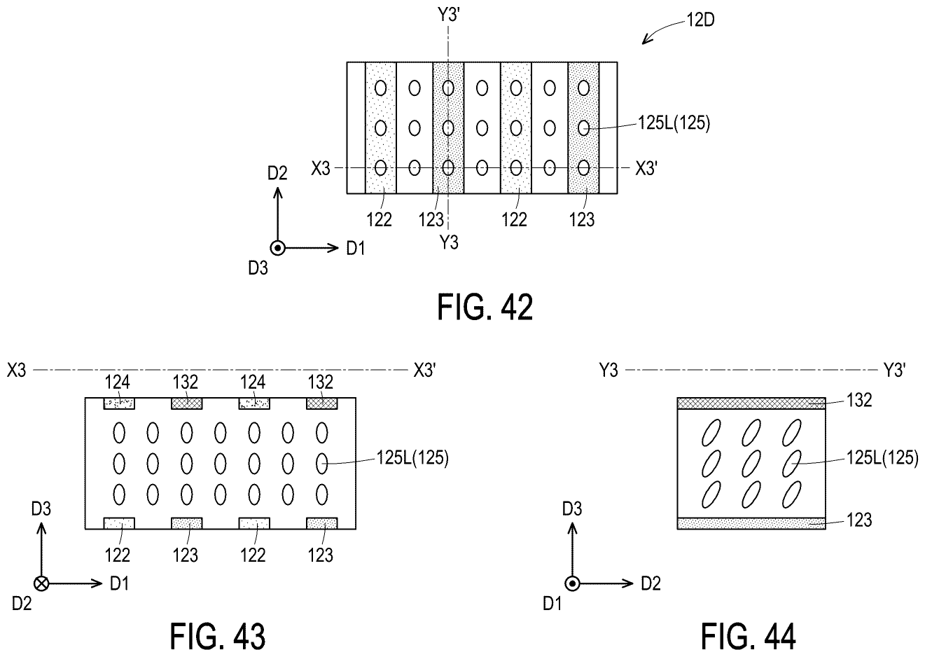

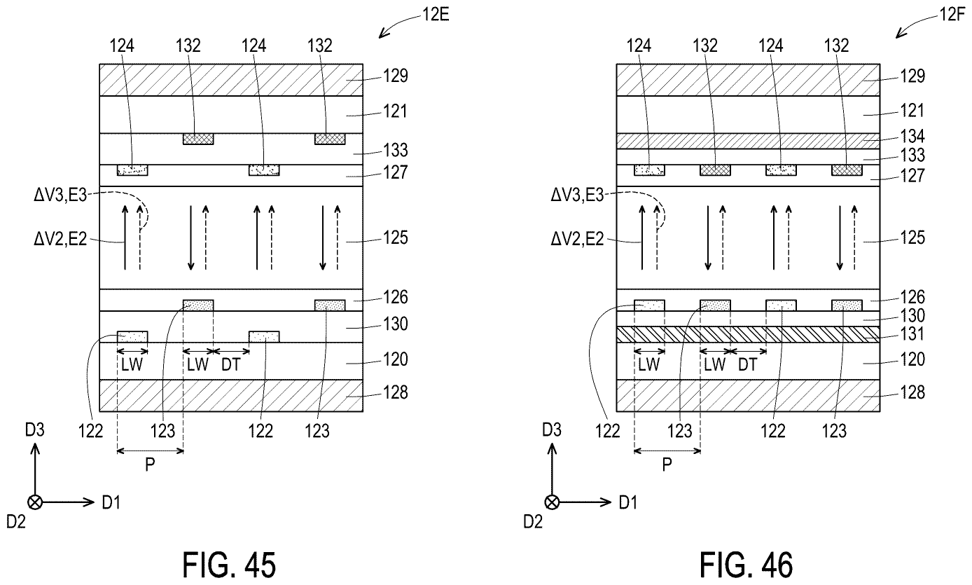

FIG. 1A and FIG. 1B are partial cross-sectional views of a privacy device under a share mode and a privacy mode according to some embodiments of the disclosure. FIG. 2 is a partial top view of a light control film in a backlight module in FIG. 1A and FIG. 1B. FIG. 3 is a partial cross-sectional view of a switchable privacy panel in FIG. 1A and FIG. 1B. FIG. 4 to FIG. 8 are partial top views of five embodiments of the switchable privacy panel in FIG. 1A and FIG. 1B. FIG. 9 is a partial top view of a first alignment layer and a second alignment layer in FIG. 3. FIG. 10 is a partial top view of a first polarizer and a second polarizer in FIG. 3. FIG. 11 is a partial top view of the switchable privacy panel in FIG. 3 under an initial state. FIG. 12 and FIG. 13 are cross-sectional views corresponding to section lines X1-X1′ and Y1-Y1′ in FIG. 11. FIG. 14 is a partial top view of the switchable privacy panel in FIG. 3 in response to the privacy device being switched to the share mode. FIG. 15 to FIG. 17 are cross-sectional views corresponding to section lines X2-X2′, Y2a-Y2a′ and Y2b-Y2b′ in FIG. 14. FIG. 18 is a partial top view of the switchable privacy panel in FIG. 3 in response to the privacy device being switched to the privacy mode. FIG. 19 and FIG. 20 are cross-sectional views corresponding to section lines X3-X3′ and Y3-Y3′ in FIG. 18. FIG. 21 and FIG. 22 are partial cross-sectional views of other embodiments of the switchable privacy panel in FIG. 1A and FIG. 1B. FIG. 23 is a partial top view of another embodiment of the switchable privacy panel in FIG. 3 under an initial state. FIG. 24 and FIG. 25 are cross-sectional views corresponding to section lines X1-X1′ and Y1-Y1′ in FIG. 23. FIG. 26 is a partial top view of another embodiment of the switchable privacy panel in FIG. 3 in response to the privacy device being switched to the share mode. FIG. 27 to FIG. 29 are cross-sectional views corresponding to section lines X2-X2′, Y2a-Y2a′ and Y2b-Y2b′ in FIG. 26. FIG. 30 is a partial top view of another embodiment of the switchable privacy panel in FIG. 3 in response to the privacy device being switched to the privacy mode. FIG. 31 and FIG. 32 are cross-sectional views corresponding to section lines X3-X3′ and Y3-Y3′ in FIG. 30. FIG. 33 is a partial cross-sectional view of another embodiment of the switchable privacy panel in FIG. 1A and FIG. 1B. FIG. 34 is a partial top view of a first polarizer and a second polarizer in FIG. 33. FIG. 35 is a partial top view of the switchable privacy panel in FIG. 33 under an initial state. FIG. 36 and FIG. 37 are cross-sectional views corresponding to section lines X1-X1′ and Y1-Y1′ in FIG. 35. FIG. 38 is a partial top view of the switchable privacy panel in FIG. 33 in response to the privacy device being switched to the share mode. FIG. 39 to FIG. 41 are cross-sectional views corresponding to section lines X2-X2′, Y2a-Y2a′ and Y2b-Y2b′ in FIG. 38. FIG. 42 is a partial top view of another embodiment of the switchable privacy panel in FIG. 33 in response to the privacy device being switched to the privacy mode. FIG. 43 and FIG. 44 are cross-sectional views corresponding to section lines X3-X3′ and Y3-Y3′ in FIG. 42. FIG. 45 and FIG. 46 are partial cross-sectional views of other embodiments of the switchable privacy panel in FIG. 1A and FIG. 1B.

In top views of the present disclosure, some elements or layers are not shown for simplicity and clarity of the top views. For the elements or layers not shown in the top views, please refer to corresponding cross-sectional views and relevant descriptions in the specification for details. It should be noted that the following embodiments can be replaced, reorganized, and mixed with features of several different embodiments without departing from the spirit of the disclosure to complete other embodiments. Features in various embodiments may be mixed and matched as long as they do not violate the spirit of the invention or conflict with each other.

Please refer to FIG. 1A to FIG. 3, a privacy device 1 can include a share mode (see FIG. 1A) and a privacy mode (see FIG. 1B). The privacy device 1 may include a display panel 10 and a switchable privacy panel 12 overlapped with the display panel 10. The switchable privacy panel 12 may include a first substrate 120, a second substrate 121, a first electrode 122, a second electrode 123, a third electrode 124 and a liquid crystal layer 125. The second substrate 121 is overlapped with the first substrate 120. The first electrode 122 is disposed on the first substrate 120. The second electrode 123 is disposed on the first substrate 120 and adjacent to the first electrode 122. The third electrode 124 is disposed on the second substrate 121. The liquid crystal layer 125 is disposed between the first substrate 120 and the second substrate 121. Under the share mode, a voltage difference ΔV1 is between the first electrode 122 and the second electrode 123, and under the privacy mode, no voltage difference is between the first electrode 122 and the second electrode 123.

Specifically, the display panel 10 can be any type of display panel, such as a non-self-luminous display panel, but not limited thereto. For example, the display panel 10 can be any type of liquid crystal display panel, such as a vertical alignment (VA) mode liquid crystal display panel, an in-plane switching (IPS) mode liquid crystal display panel, a fringe field switching (FFS) mode liquid crystal display panel, a twisted nematic (TN) mode liquid crystal display panel, an electronically controlled birefringence (ECB) mode liquid crystal display panel or the like.

In embodiments in which the display panel 10 is a non-self-luminous display panel, the privacy device 1 can further include a backlight module 14 disposed under the display panel 10 to provide light beam B for display. The backlight module 14 can be any type of backlight module, such as a side-lit backlight module or a direct-lit backlight module, but not limited thereto. Although not shown, the backlight module 14 may include a light source, such as one or more cold cathode fluorescent lamps (CCFL) or one or more light emitting diodes (LED), but not limited thereto. Although not shown, the backlight module 14 may include one or more optical films, such as one or more diffusion sheets, one or more prism sheets (e.g., a prism sheet, a reverse prism sheet, or the like) or a combination thereof.

In some embodiments, the backlight module 14 has a narrow light distribution or a collimated light distribution. For example, the backlight module 14 may include a light control film 140 (e.g., louver array film) to narrow the light distribution of light beam B output from the backlight module 14. The light control film 140 may include a plurality of opaque structures 140S (e.g., louvers) arranged in an arrangement direction (e.g., a direction D1) of the first electrode 122 and the second electrode 123. Correspondingly, the light distribution of light beam B output from the backlight module 14 can be narrowed in the direction D1.

In some embodiments, as shown in FIG. 1A and FIG. 1B, the switchable privacy panel 12 is disposed between the display panel 10 and the backlight module 14. The switchable privacy panel 12 can be used to adjust light distribution according to the mode of the privacy device 1. In some embodiments, as shown in FIG. 1A, in response to the privacy device 1 being switched to the share mode, the switchable privacy panel 12 may be switched to a diffusion mode to diffuse incident light (e.g., light beam B from the backlight module 14) so that the privacy device 1 under the share mode has a wide light distribution (or viewing angle). On the other hand, as shown in FIG. 1B, in response to the privacy device 1 being switched to the privacy mode, the switchable privacy panel 12 may be switched to an absorption mode to absorb a portion of incident light (e.g., light beam B with larger incident angle is absorbed by the switchable privacy panel 12) so that the privacy device 1 under the privacy mode has a narrow light distribution (or viewing angle).

Since the switchable privacy panel 12 can adjust (e.g., expand/broaden or narrow) light distribution according to the mode of the privacy device 1, the light distribution of the light beam B from the backlight module 14 does not need to be as narrow as the light distribution of the light beam B output from the privacy device 1 (or the switchable privacy panel 12) in the privacy mode. Specifically, as shown in FIG. 1A and FIG. 1B, the light distribution of the light beam B from the backlight module 14 can be wider than the light distribution of the light beam B output from the switchable privacy panel 12 in FIG. 1B. In this way, the light loss caused by light diffusion of the switchable privacy panel 12 under the diffusion mode (shown in FIG. 1A) can be reduced, thereby improving the brightness of the privacy device 1 under the share mode.

In some embodiments, as shown in FIG. 1A and FIG. 1B, the privacy device 1 may further include a touch sensor 16. The touch sensor 16 can be disposed on the display panel 10. The touch sensor 16 can be any type of touch sensor. For example, the touch sensor 16 can be a discrete type touch sensor, an on-cell type touch sensor, or an in-cell type touch sensor, but not limited thereto.

Please refer to FIG. 3 for details of the switchable privacy panel 12. In the switchable privacy panel 12, the first substrate 120 and the second substrate 121 are stacked in a thickness direction (e.g., a direction D3) of the switchable privacy panel 12. The first substrate 120 and the second substrate 121 can be rigid substrates or flexible substrates. In addition, the first substrate 120 and the second substrate 121 are transparent substrates to allow light beam B (see FIG. 1A or FIG. 1B) to pass through. For example, materials of the first substrate 120 and the second substrate 121 include plastic or glass, but not limited thereto.

The first electrode 122 and the second electrode 123 are disposed on the same side of the first substrate 120. For example, the first electrode 122 and the second electrode 123 are both disposed on a side of the first substrate 120 facing the liquid crystal layer 125. Materials of the first electrode 122 and the second electrode 123 may include light transmitting conductive materials, such as metal oxide, metal mesh, or graphene, but not limited thereto. The metal oxide may include indium tin oxide (ITO), indium zinc oxide (IZO), indium gallium zinc oxide (IGZO), or the like, but not limited thereto.

In some embodiments, as shown in FIG. 3, the first electrode 122 and the second electrode 123 are disposed on the same plane (e.g., the upper surface of the first substrate 120 shown in FIG. 3) and belong to the same patterned conductive layer (e.g., a first conductive layer), but not limited thereto. In some embodiments, as shown in FIG. 3, the switchable privacy panel 12 includes a plurality of first electrodes 122 and a plurality of second electrodes 123, wherein the plurality of first electrodes 122 and the plurality of second electrodes 123 are alternately arranged in the direction D1. In some embodiments, in a cross-sectional view, as shown in FIG. 3, a pitch P between the first electrode 122 and the second electrode 123 is 5 μm to 20 μm. In some embodiments, in a cross-sectional view, as shown in FIG. 3, a ratio between a line width LW of each of the first electrode 122 and the second electrode 123 and a space DT between the first electrode 122 and the second electrode 123 is 2:8 to 8:2, i.e., LW: DT=2:8 to 8:2.

In some embodiments, in a top view, shapes of the first electrode 122 and the second electrode 123 are respectively linear (see FIG. 4), sawtooth (see FIG. 5), wedge-shaped (see FIG. 7), or a combination of at least two of the above (see FIG. 6). As shown in FIG. 4, the plurality of first electrodes 122 and the plurality of second electrodes 123 may be strip electrodes alternately arranged in the direction D1 and extending in a direction D2 intersected with the direction D1. The direction D1 and the direction D2 are perpendicular to the direction D3. In some embodiments, the direction D1 and the direction D2 are perpendicular to each other.

As shown in FIG. 5, the plurality of first electrodes 122 and the plurality of second electrodes 123 may be sawtooth electrodes alternately arranged in the direction D1. The sawtooth electrode includes at least one inflection region IF. The extension direction DE of the sawtooth electrode refers to a direction perpendicular to a line width direction DLW of the sawtooth electrode at the inflection region IF. In the embodiment shown in FIG. 5, the extension direction DE of the sawtooth electrode is, for example, parallel to the direction D2. In other words, in the embodiment shown in FIG. 5, the plurality of first electrodes 122 and the plurality of second electrodes 123 are considered to extend in the direction D2.

As shown in FIG. 6, the plurality of first electrodes 122 and the plurality of second electrodes 123 may be combination electrodes alternately arranged in the direction D1, each of the combination electrodes being a combination of a strip electrode and a sawtooth electrode. The combination electrode can include more than one inflection regions IF. The extension direction DE of the combination electrode refers to a direction perpendicular to a line width direction DLW of the combination electrode at one of the inflection regions IF. In the embodiment shown in FIG. 6, the extension direction DE of the combination electrode is, for example, parallel to the direction D2. In other words, in the embodiment shown in FIG. 6, the plurality of first electrodes 122 and the plurality of second electrodes 123 are considered to extend in the direction D2.

As shown in FIG. 7, the plurality of first electrodes 122 and the plurality of second electrodes 123 may be wedge-shaped electrodes alternately arranged in the direction D1. The extension direction DE of the wedge-shaped electrode refers to a direction perpendicular to a line width direction DLW of the wedge-shaped electrode at an widest portion of the wedge-shaped electrode. In the embodiment shown in FIG. 7, the extension direction DE of the wedge-shaped electrode is, for example, parallel to the direction D2. In other words, in the embodiment shown in FIG. 7, the plurality of first electrodes 122 and the plurality of second electrodes 123 are considered to extend in the direction D2.

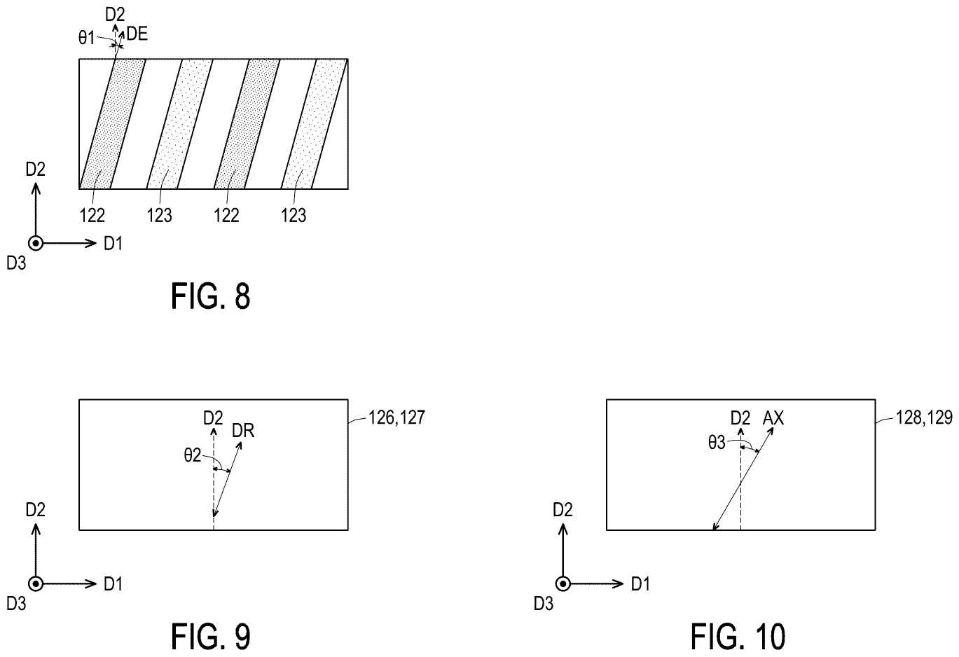

In some embodiments, as shown in FIG. 8, an angle θ1 between an extension direction DE of the first electrode 122 or the second electrode 123 and a direction (e.g., the direction D2) perpendicular to an arrangement direction (e.g., the direction D1) of the first electrode 122 and the second electrode 123 may be equal to or less than 30 degrees. For example, the plurality of electrodes (including the plurality of first electrodes 122 and the plurality of second electrodes 123) may be rotated clockwise (as shown in FIG. 8) or counterclockwise (not shown) by the angle θ1 from the direction D2. Alternatively, the extension direction DE of the first electrode 122 and the second electrode 123 may be parallel to the direction D2, such that the angle θ1=0, as shown in FIG. 4.

Please refer back to FIG. 3, the third electrode 124 is, for example, disposed on a side of the second substrate 121 facing the liquid crystal layer 125. A material of the third electrode 124 may include light transmitting conductive materials, such as metal oxide, metal mesh, or graphene, but not limited thereto. In some embodiments, as shown in FIG. 3, the third electrode 124 is a non-patterned conductive layer (e.g., a second conductive layer) across the surface of the second substrate 121, but not limited thereto.

The liquid crystal layer 125 is disposed between the first conductive layer (including the first electrode 122 and the second electrode 123) and the second conductive layer (including the third electrode 124). In some embodiments, the liquid crystal layer 125 is an ECB mode liquid crystal cell, and phase retardation of the liquid crystal layer 125 may be 500 nm to 3000 nm.

In some embodiments, as shown in FIG. 3, the switchable privacy panel 12 may further include a first alignment layer 126 and a second alignment layer 127, wherein the first alignment layer 126 is disposed between the liquid crystal layer 125 and the first substrate 120, and the second alignment layer 127 is disposed between the liquid crystal layer 125 and the second substrate 121. In addition, the first electrode 122 and the second electrode 123 may be disposed between the first alignment layer 126 and the first substrate 120, and the third electrode 124 may be disposed between the second alignment layer 127 and the second substrate 121.

In some embodiments, the first alignment layer 126 and the second alignment layer 127 are both horizontal alignment layers, as shown in FIG. 9, an angle θ2 between a direction (e.g., the direction D2) perpendicular to the arrangement direction (e.g., the direction D1) of the first electrode 122 and the second electrode 123 and a rubbing direction DR of each of the first alignment layer 126 and the second alignment layer 127 may be equal to or less than 10 degrees. For example, the rubbing direction DR of each of the first alignment layer 126 and the second alignment layer 127 may be rotated clockwise (as shown in FIG. 9) or counterclockwise (not shown) by the angle θ2 from the direction D2. Alternatively, the rubbing direction DR of each of the first alignment layer 126 and the second alignment layer 127 may be parallel to the direction D2, such that the angle θ2=0.

In some embodiments, as shown in FIG. 3, the switchable privacy panel 12 may further include a first polarizer 128 and a second polarizer 129, wherein the first substrate 120 is disposed between the liquid crystal layer 125 and the first polarizer 128, and the second substrate 121 is disposed between the liquid crystal layer 125 and the second polarizer 129. In addition, first polarizer 128 and the first alignment layer 126 may be disposed on opposite sides of the first substrate 120, and the second polarizer 129 and the second alignment layer 127 may be disposed on opposite sides of the second substrate 121.

In some embodiments, the first polarizer 128 and the second polarizer 129 are both linear polarizers, as shown in FIG. 10, an angle θ3 between a direction (e.g., the direction D2) perpendicular to the arrangement direction (e.g., the direction D1) of the first electrode 122 and the second electrode 123 and an absorption axis AX of each of the first polarizer 128 and the second polarizer 129 may be equal to or less than 10 degrees. For example, the absorption axis AX of each of the first polarizer 128 and the second polarizer 129 may be rotated clockwise (as shown in FIG. 10) or counterclockwise (not shown) by the angle θ3 from the direction D2. Alternatively, the absorption axis AX of each of the first polarizer 128 and the second polarizer 129 may be parallel to the direction D2, such that the angle θ3=0.

In the embodiments of the disclosure, the switchable privacy panel 12 may be color filter free, such that the light entering the switchable privacy panel 12 and the light output from the switchable privacy panel 12 have the same color.

Please refer to FIG. 11 to FIG. 20, the liquid crystal layer 125 includes a plurality of liquid crystal molecules 125L. The tilting state of the plurality of liquid crystal molecules 125L may be changed according to an electric field (generated by applying a voltage to the first electrode, the second electrode and/or the third electrode). Specifically, the long axes of the plurality of liquid crystal molecules 125L may be substantially parallel to the electric field in the region where the plurality of liquid crystal molecules 125L are located. When no electric field exists in the region where the plurality of liquid crystal molecules 125L are located, the plurality of liquid crystal molecules 125L may tilt or lie flat according to the alignment directions (e.g., rubbing directions) of the first alignment layer 126 and the second alignment layer 127. In the embodiments shown in FIG. 11 to FIG. 20, the alignment directions of the first alignment layer 126 and the second alignment layer 127 are, for example, parallel to the direction D2. Therefore, under the initial state of the switchable privacy panel 12 (i.e., no voltage is applied to the first electrode 122, the second electrode 123 and the third electrode 124), as shown in FIG. 11 to FIG. 13, the long axes of the plurality of liquid crystal molecules 125L may be substantially parallel to the direction D2.

In response to the privacy device being switched to the share mode, as shown in FIG. 3 and FIG. 14 to FIG. 17, a voltage difference ΔV1 may be provided between the first electrode 122 and the second electrode 123, and a voltage difference ΔV2 may be provided between the third electrode 124 and the first electrode 122 and/or between the third electrode 124 and the second electrode 123. For example, when the frame is odd, a voltage of +X volt is provided to the first electrode 122, a voltage of −X volt is provided to the second electrode 123, and a voltage of 0 volt is provided to the third electrode 124; and when the frame is even, a voltage pf −X volt is provided to the first electrode 122, a voltage of +X volt is provided to the second electrode 123, and a voltage of 0 volt is provided to the third electrode 124, wherein 1≤X≤30, but not limited thereto.

Accordingly, an electric field E1 is generated between the first electrode 122 and the second electrode 123, and an electric field E2 is generated between the third electrode 124 and the first electrode 122 and/or between the third electrode 124 and the second electrode 123. As a result, the long axes of at least a portion of the liquid crystal molecules 125L located between the first electrode 122 and the second electrode 123 are changed to be parallel to the direction D1, and the long axes of at least a portion of the liquid crystal molecules 125L located between the third electrode 124 and the first electrode 122 and/or between the third electrode 124 and the second electrode 123 are changed to be parallel to the direction D3.

The periodic refractive index distribution obtained by the periodic distribution of the liquid crystal molecules 125L shown in FIG. 14 or FIG. 15 can diffract light, so that when the privacy device is under the share mode, the switchable privacy panel 12 can expand/widen the light distribution.

In response to the privacy device being switched to the privacy mode, as shown in FIG. 3 and FIG. 18 to FIG. 20, no voltage difference may be provided between the first electrode 122 and the second electrode 123, and a voltage difference ΔV3 may be provided between the third electrode 124 and the first electrode 122 and/or between the third electrode 124 and the second electrode 123. For example, when the frame is odd, a voltage of +Y volt is provided to the first electrode 122, a voltage of +Y volt is provided to the second electrode 123, and a voltage of 0 volt is provided to the third electrode 124; and when the frame is even, a voltage of −Y volt is provided to the first electrode 122, a voltage of −Y volt is provided to the second electrode 123, and a voltage of 0 volt is provided to the third electrode 124, wherein 1≤Y≤10, but not limited thereto.

Accordingly, an electric field E3 is generated between the third electrode 124 and the first electrode 122 and/or between the third electrode 124 and the second electrode 123. In some embodiments, ΔV3<ΔV2, and E3<E2. As a result, the long axes of at least a portion of the liquid crystal molecules 125L may be inclined relative to the direction D3 and the direction D2, as shown in FIG. 20.

The oblique status of the liquid crystal molecules 125L can reduce the large-angle light beam passing through the second polarizer 129 (shown in FIG. 3). For example, the large-angle light beam may be absorbed by the second polarizer 129, so that when the privacy device is under the privacy mode, the switchable privacy panel 12 can narrow the light distribution.

In some embodiments, as shown in FIG. 21, the switchable privacy panel 12A may further include a passivation layer 130 disposed between the first electrode 122 and the second electrode 123. For example, the passivation layer 130 may be disposed on the first substrate 120 and cover the first electrode 122, the second electrode 123 may be disposed on the passivation layer 130, and the first alignment layer 126 may be disposed on the passivation layer 130 and cover the second electrode 123. A material of the passivation layer 130 includes, for example, an inorganic insulating material, an organic insulating material, or a combination thereof.

The driving methods of the switchable privacy panel 12A under different modes can refer to the driving methods of the switchable privacy panel 12 (see FIG. 3) under different modes, which will not be repeated here.

In some embodiments, as shown in FIG. 22, the switchable privacy panel 12B may further include a fourth electrode 131 disposed on the first substrate 120 and a passivation layer 130 disposed between the fourth electrode 131 and the first electrode 122 and between the fourth electrode 131 and the second electrode 123. For example, the fourth electrode 131 is disposed between the passivation layer 130 and the first substrate 120. A material of the fourth electrode 131 may include light transmitting conductive materials, such as metal oxide, metal mesh, or graphene, but not limited thereto. In some embodiments, as shown in FIG. 22, the fourth electrode 131 is a non-patterned conductive layer (e.g., a third conductive layer) across the surface of the first substrate 120, but not limited thereto.

Under the share mode, a voltage difference ΔV4 may be provided between the fourth electrode 131 and the first electrode 122 and/or between the fourth electrode 131 and the second electrode 123, and no voltage difference may be provided between the fourth electrode 131 and the third electrode 124. For example, when the frame is odd, a voltage of +X volt is provided to the first electrode 122, a voltage of −X volt is provided to the second electrode 123, a voltage of 0 volt is provided to the third electrode 124, and a voltage of 0 volt is provided to the fourth electrode 131; and when the frame is even, a voltage pf −X volt is provided to the first electrode 122, a voltage of +X volt is provided to the second electrode 123, a voltage of 0 volt is provided to the third electrode 124, and a voltage of 0 volt is provided to the fourth electrode 131, wherein 1≤X≤30, but not limited thereto. Accordingly, an electric field E4 is further generated between the fourth electrode 131 and the first electrode 122 and/or between the fourth electrode 131 and the second electrode 123.

Under the privacy mode, no voltage difference may be provided between the fourth electrode 131 and the first electrode 122 and/or between the fourth electrode 131 and the second electrode 123, and a voltage difference ΔV3 may be provided between the third electrode 124 and the first electrode 122, between the third electrode 124 and the second electrode 123 and/or between the third electrode 124 and the fourth electrode 131. For example, when the frame is odd, a voltage of +Y volt is provided to the first electrode 122, a voltage of +Y volt is provided to the second electrode 123, a voltage of 0 volt is provided to the third electrode 124, and a voltage of +Y volt is provided to the fourth electrode 131; and when the frame is even, a voltage of −Y volt is provided to the first electrode 122, a voltage of −Y volt is provided to the second electrode 123, a voltage of 0 volt is provided to the third electrode 124, and a voltage of −Y volt is provided to the fourth electrode 131, wherein 1≤Y≤10, but not limited thereto.

Alternatively, under the share mode, when the frame is odd, a voltage of +X volt is provided to the first electrode 122, a voltage of +X volt is provided to the second electrode 123, a voltage of 0 volt is provided to the third electrode 124, and a voltage of 0 volt is provided to the fourth electrode 131; and when the frame is even, a voltage pf −X volt is provided to the first electrode 122, a voltage of −X volt is provided to the second electrode 123, a voltage of 0 volt is provided to the third electrode 124, and a voltage of 0 volt is provided to the fourth electrode 131, wherein 1≤X≤30, but not limited thereto. In addition, under the privacy mode, when the frame is odd, a voltage of +Y volt is provided to the first electrode 122, a voltage of +Y volt is provided to the second electrode 123, a voltage of 0 volt is provided to the third electrode 124, and a voltage of +Y volt is provided to the fourth electrode 131; and when the frame is even, a voltage of −Y volt is provided to the first electrode 122, a voltage of −Y volt is provided to the second electrode 123, a voltage of 0 volt is provided to the third electrode 124, and a voltage of −Y volt is provided to the fourth electrode 131, wherein 1≤Y≤10, but not limited thereto.

In some embodiments, as another option, one of the first alignment layer 126 and the second alignment layer 127 (as shown in FIG. 3) may be a horizontal alignment layer, while the other one of the first alignment layer 126 and the second alignment layer 127 may be a vertical alignment layer. For example, the first alignment layer 126 in FIG. 3 may be a horizontal alignment layer, an angle θ2 (see FIG. 9) between a direction (e.g., the direction D2) perpendicular to the arrangement direction (e.g., the direction D1) of the first electrode 122 and the second electrode 123 and a rubbing direction DR of the first alignment layer 126 may be equal to or less than 10 degrees, and the second alignment layer 127 may be a vertical alignment layer. In the embodiments shown in FIG. 23 to FIG. 32, the alignment direction of the first alignment layer 126 is, for example, parallel to the direction D2, while the alignment direction of the second alignment layer 127 is, for example, substantially parallel to the direction D3. In this way, the long axes of the liquid crystal molecules 125L closer to the first alignment layer 126 (not shown in FIG. 23 to FIG. 25) may be more parallel to the direction D2, while the long axes of the liquid crystal molecules 125L closer to the second alignment layer 127 (not shown in FIG. 23 to FIG. 25) may be more parallel to the direction D3. In addition, under the initial state of the switchable privacy panel 12C (i.e., no voltage is applied to the first electrode 122, the second electrode 123 and the third electrode 124), as shown in FIG. 23 to FIG. 25, the liquid crystal molecules 125L stacked in sequence in the direction D3 gradually change from a lying state (the long axis is substantially parallel to the direction D2) to an upright state (the long axis is substantially parallel to the direction D3). On the other hand, when there is an electric field in the region where the liquid crystal molecules 125L are located, the long axes of the plurality of liquid crystal molecules 125L may be substantially parallel to the electric field. FIG. 26 to FIG. 29 illustrate the tilting state of the plurality of liquid crystal molecules 125L when the privacy device is switched to the share mode, and FIG. 30 to FIG. 32 illustrate the tilting state of the plurality of liquid crystal molecules 125L when the privacy device is switched to the privacy mode. The driving methods of the switchable privacy panel 12C under different modes can refer to the driving methods of the switchable privacy panel 12 (see FIG. 3) under different modes, which will not be repeated here.

In some embodiments, as shown in FIG. 33, the switchable privacy panel 12D may further include a fifth electrode 132 disposed on the second substrate 121 and adjacent to the third electrode 124, wherein the third electrode 124 is overlapped with the first electrode 122, and the fifth electrode 132 is overlapped with the second electrode 123. For example, the third electrode 124 and the fifth electrode 132 are disposed on the same plane (e.g., the lower surface of the second substrate 121) and belong to the same patterned conductive layer, but not limited thereto. In some embodiments, as shown in FIG. 33, the switchable privacy panel 12D includes a plurality of third electrodes 124 and a plurality of fifth electrodes 132, wherein the plurality of third electrodes 124 and the plurality of fifth electrodes 132 are alternately arranged in the direction D1. The design parameters (e.g., pitch, line width, space, shapes, extension direction, or the like) of the third electrode 124 and the fifth electrode 132 may be the same as or similar to those of the first electrode 122 and the second electrode 123, which will not be repeated here. Details of the other layers in the switchable privacy panel 12D may refer to the above (e.g., FIG. 3 and the relative description), which will not be repeated here.

In the embodiments shown in FIG. 33, an angle θ3 between an arrangement direction (e.g., the direction D1) of the first electrode 122 and the second electrode 123 and an absorption axis AX of each of the first polarizer 128 and the second polarizer 128 may be equal to or less than 10 degrees. For example, the absorption axis AX of each of the first polarizer 128 and the second polarizer 129 may be rotated clockwise (as shown in FIG. 34) or counterclockwise (not shown) by the angle θ3 from the direction D1. Alternatively, the absorption axis AX of each of the first polarizer 128 and the second polarizer 129 may be parallel to the direction D2, such that the angle θ3=0.

In the embodiments shown in FIG. 35 to FIG. 44, the alignment directions of the first alignment layer 126 and the second alignment layer 127 are, for example, parallel to the direction D2. Therefore, under the initial state of the switchable privacy panel 12D (i.e., no voltage is applied to the first electrode 122, the second electrode 123, the third electrode 124 and the fifth electrode 132), as shown in FIG. 35 to FIG. 37, the long axes of the plurality of liquid crystal molecules 125L may be substantially parallel to the direction D2.

In response to the privacy device being switched to the share mode, as shown in FIG. 33 and FIG. 38 to FIG. 41, no voltage difference may be provided the fifth electrode 132 and the first electrode 122 and/or between the third electrode 124 and the second electrode 123, and a voltage difference ΔV2 may be provided between the first electrode 122 and the third electrode 124 and/or between the fifth electrode 132 and the second electrode 123. For example, when the frame is odd, a voltage of +X volt is provided to the first electrode 122, a voltage of 0 volt is provided to the second electrode 123, a voltage of 0 volt is provided to the third electrode 124, and a voltage of +X volt is provided to the fifth electrode 132; and when the frame is even, a voltage of −X volt is provided to the first electrode 122, a voltage of 0 volt is provided to the second electrode 123, a voltage of 0 volt is provided to the third electrode 124, and a voltage of −X volt is provided to the fifth electrode 132, wherein 1≤X≤30, but not limited thereto.

Accordingly, an electric field E2 is generated between the first electrode 122 and the third electrode 124 and/or between the fifth electrode 132 and the second electrode 123, and almost no electric field is generated between the fifth electrode 132 and the first electrode 122 and/or between the third electrode 124 and the second electrode 123. As a result, the long axes of at least a portion of the liquid crystal molecules 125L located between the first electrode 122 and the third electrode 124 and/or between the fifth electrode 132 and the second electrode 123 are changed to be parallel to the direction D3. In some embodiments, a voltage difference (not shown) may be between the first electrode 122 and the second electrode 123 and/or between the fifth electrode 132 and the third electrode 124, and therefore a horizontal electric field (not shown) may be generated between the first electrode 122 and the second electrode 123 and/or between the fifth electrode 132 and the third electrode 124. In some embodiments, the voltage difference (not shown) may be between the first electrode 122 and the second electrode 123 and/or between the fifth electrode 132 and the third electrode 124 can be adjusted to make the kinetic energy of the liquid crystal molecules 125L generated by the horizontal electric field smaller than the anchoring energy of the alignment layers (including the first alignment layer 126 and the second alignment layer 127 shown in FIG. 33), thereby maintaining the long axis of the liquid crystal molecules 125L located between the first electrode 122 and the second electrode 123 and/or between the fifth electrode 132 and the third electrode 124 parallel to the direction D2.

In response to the privacy device being switched to the privacy mode, as shown in FIG. 33 and FIG. 42 to FIG. 44, no voltage difference may be provided between the first electrode 122 and the second electrode 123 and/or between the third electrode 124 and the fifth electrode 132, and a voltage difference ΔV3 may be provided between the first electrode 122 and the third electrode 124 and/or between the fifth electrode 132 and the second electrode 123. For example, when the frame is odd, a voltage of +Y volt is provided to the first electrode 122, a voltage of +Y volt is provided to the second electrode 123, a voltage of 0 volt is provided to the third electrode 124, and a voltage of 0 volt is provided to the fifth electrode 132; and when the frame is even, a voltage of −Y volt is provided to the first electrode 122, a voltage of −Y volt is provided to the second electrode 123, a voltage of 0 volt is provided to the third electrode 124, and a voltage of 0 volt is provided to the fifth electrode 132, wherein 1≤Y≤10, but not limited thereto.

Accordingly, an electric field E3 is generated between the first electrode 122 and the third electrode 124 and/or between the fifth electrode 132 and the second electrode 123. In some embodiments, ΔV3<ΔV2, and E3<E2. As a result, the long axes of at least a portion of the liquid crystal molecules 125L may be inclined relative to the direction D3 and the direction D2, as shown in FIG. 44.

In some embodiments, as shown in FIG. 45, the switchable privacy panel 12E may further include a passivation layer 133 disposed between the third electrode 124 and the fifth electrode 132. For example, the passivation layer 133 may be disposed on a surface of the second substrate 121 facing the liquid crystal layer 125 and cover the fifth electrode 132, the third electrode 124 may be disposed on the passivation layer 133, and the second alignment layer 127 may be disposed on the passivation layer 133 and cover the third electrode 124. A material of the passivation layer 133 includes, for example, an inorganic insulating material, an organic insulating material, or a combination thereof.

The driving methods of the switchable privacy panel 12E under different modes can refer to the driving methods of the switchable privacy panel 12D (see FIG. 33) under different modes, which will not be repeated here.

In some embodiments, as shown in FIG. 46, the switchable privacy panel 12F may further include the fourth electrode 131, the passivation layer 130, a sixth electrode 134 and the passivation layer 133. The disposition of the fourth electrode 131 and the passivation layer 130 may refer to FIG. 22 and the relative description above, which will not be repeated here. The sixth electrode 134 may be disposed between the passivation layer 133 and the second substrate 121. A material of the sixth electrode 134 may include light transmitting conductive materials, such as metal oxide, metal mesh, or graphene, but not limited thereto. In some embodiments, as shown in FIG. 46, the sixth electrode 134 is a non-patterned conductive layer across the surface of the second substrate 121, but not limited thereto. The passivation layer 133 may be disposed between the third electrode 124 and the sixth electrode 134 and between the fifth electrode 132 and the sixth electrode 134.

Under the share mode, for example, when the frame is odd, a voltage of +X volt is provided to the first electrode 122, a voltage of 0 volt is provided to the second electrode 123, a voltage of 0 volt is provided to the third electrode 124, a voltage of 0 volt is provided to the fourth electrode 131, a voltage of +X volt is provided to the fifth electrode 132, and a voltage of 0 volt is provided to the sixth electrode 134; and when the frame is even, a voltage of −X volt is provided to the first electrode 122, a voltage of 0 volt is provided to the second electrode 123, a voltage of 0 volt is provided to the third electrode 124, a voltage of 0 volt is provided to the fourth electrode 131, a voltage of −X volt is provided to the fifth electrode 132, and a voltage of 0 volt is provided to the sixth electrode 134, wherein 1≤X≤30, but not limited thereto.

Under the privacy mode, for example, when the frame is odd, a voltage of +Y volt is provided to the first electrode 122, a voltage of +Y volt is provided to the second electrode 123, a voltage of 0 volt is provided to the third electrode 124, a voltage of +Y volt is provided to the fourth electrode 131, a voltage of 0 volt is provided to the fifth electrode 132, and a voltage of 0 volt is provided to the sixth electrode 134; and when the frame is even, a voltage of −Y volt is provided to the first electrode 122, a voltage of −Y volt is provided to the second electrode 123, a voltage of 0 volt is provided to the third electrode 124, a voltage of −Y volt is provided to the fourth electrode 131, a voltage of 0 volt is provided to the fifth electrode 132, and a voltage of 0 volt is provided to the sixth electrode 134, wherein 1≤Y≤10, but not limited thereto.

In summary, in the embodiments of the disclosure, since the switchable privacy panel can adjust (e.g., expand/broaden or narrow) light distribution according to the mode of the privacy device, the privacy device can have an improved display quality (e.g., the privacy device under the share mode may have a wide light distribution and improved brightness).

The above embodiments are only used to illustrate the technical solution of the disclosure, but not to limit it; although the disclosure has been described in detail with reference to the foregoing embodiments, those of ordinary skill in the art should understand that they can still modify the technical solutions recorded in the foregoing embodiments, or make equivalent substitutions for some or all of the technical features. However, these modifications or substitutions do not cause the essence of the corresponding technical solution to deviate from the scope of the technical solution of each embodiment of the disclosure.

Although the embodiments and advantages of the disclosure have been disclosed above, it should be understood that anyone with ordinary skill in the art can make changes, substitutions and modifications without departing from the spirit and scope of the disclosure. Furthermore, the features of various embodiments can be mixed and replaced at will to form other new embodiments. In addition, the protection scope of the disclosure is not limited to the processes, machines, manufacturing, material compositions, devices, methods and steps in the specific embodiments described in the specification. Any process, machine, manufacture, material compositions, device, method, and steps, now or hereafter developed, which may be understood from this disclosure by any person having ordinary knowledge in the art, may be used in accordance with this disclosure, provided that substantially the same function can be performed, or substantially the same result can be obtained, in the embodiments described herein. Accordingly, the scope of protection of the disclosure includes the processes, machines, manufacturing, material compositions, devices, methods, and steps described above. In addition, each claim constitutes an individual embodiment, and the scope of protection of the disclosure also includes a combination of the claims and embodiments. The scope of protection of the disclosure shall be as defined in the scope of the patent application attached hereto.

Anyone with ordinary knowledge in the relevant technical field can learn from the disclosure It is understood that processes, machines, manufacturing, material compositions, devices, methods and steps currently or developed in the future can be used according to the present disclosure as long as they can perform substantially the same functions or obtain substantially the same results in the embodiments described herein. Therefore, the protection scope of the present disclosure includes the above-mentioned processes, machines, manufacturing, material compositions, devices, methods and steps. In addition, each claim constitutes an individual embodiment, and the protection scope of the present disclosure also includes combinations of each claim and embodiment. The scope of protection of this disclosure shall be determined by the scope of the accompanying patent application.

What is claimed is:

1. A privacy device comprising a share mode and a privacy mode, and the privacy device comprising:
a display panel; and
a switchable privacy panel overlapped with the display panel and comprising;
a first substrate;
a second substrate overlapped with the first substrate;
a first electrode disposed on the first substrate;
a second electrode disposed on the first substrate and adjacent to the first electrode;
a third electrode disposed on the second substrate; and
a liquid crystal layer disposed between the first substrate and the second substrate, wherein:
under the share mode, a voltage difference is between the first electrode and the second electrode, and
under the privacy mode, no voltage difference is between the first electrode and the second electrode.

2. The privacy device according to claim 1, wherein under the privacy mode, a voltage difference is between the third electrode and the first electrode and/or between the third electrode and the second electrode.

3. The privacy device according to claim 1, wherein the switchable privacy panel further comprises:
a fourth electrode disposed on the first substrate; and
a passivation layer disposed between the fourth electrode and the first electrode and between the fourth electrode and the second electrode.

4. The privacy device according to claim 3, wherein under the privacy mode, no voltage difference is between the fourth electrode and the first electrode and/or between the fourth electrode and the second electrode.

5. The privacy device according to claim 3, wherein under the share mode, a voltage difference is between the fourth electrode and the first electrode and/or between the fourth electrode and the second electrode, and no voltage difference is between the fourth electrode and the third electrode.

6. The privacy device according to claim 1, wherein under the share mode, a voltage difference is between the third electrode and the first electrode and/or between the third electrode and the second electrode.

7. The privacy device according to claim 1, wherein phase retardation of the liquid crystal layer is 500 nm to 3000 nm.

8. The privacy device according to claim 1, wherein:
the switchable privacy panel further comprises a first alignment layer and a second alignment layer,
the first alignment layer is a horizontal alignment layer disposed between the liquid crystal layer and the first substrate,
the second alignment layer is a horizontal alignment layer disposed between the liquid crystal layer and the second substrate, and
an angle between a direction perpendicular to an arrangement direction of the first electrode and the second electrode and a rubbing direction of each of the first alignment layer and the second alignment layer is equal to or less than 10 degrees.

9. The privacy device according to claim 1, wherein:
the switchable privacy panel further comprises a first alignment layer and a second alignment layer,
the first alignment layer is a horizontal alignment layer disposed between the liquid crystal layer and the first substrate,
the second alignment layer is a vertical alignment layer disposed between the liquid crystal layer and the second substrate, and
an angle between a direction perpendicular to an arrangement direction of the first electrode and the second electrode and a rubbing direction of the first alignment layer is equal to or less than degrees.

10. The privacy device according to claim 1, wherein:
the switchable privacy panel further comprises a first polarizer and a second polarizer,
the first substrate is disposed between the liquid crystal layer and the first polarizer,
the second substrate is disposed between the liquid crystal layer and the second polarizer, and
an angle between a direction perpendicular to an arrangement direction of the first electrode and the second electrode and an absorption axis of each of the first polarizer and the second polarizer is equal to or less than 10 degrees.

11. The privacy device according to claim 1, wherein:
the switchable privacy panel further comprises a fifth electrode disposed on the second substrate and adjacent to the third electrode,
the third electrode is overlapped with the first electrode,
the fifth electrode is overlapped with the second electrode,
under the share mode, no voltage difference is between the fifth electrode and the first electrode and/or between the third electrode and the second electrode, and a voltage difference is between the first electrode and the third electrode and/or between the fifth electrode and the second electrode, and
under the privacy mode, no voltage difference is between the first electrode and the second electrode and/or between the third electrode and the fifth electrode, and a voltage difference is between the first electrode and the third electrode and/or between the fifth electrode and the second electrode.

12. The privacy device according to claim 1, wherein:
the switchable privacy panel further comprises a first polarizer and a second polarizer,
the first substrate is disposed between the liquid crystal layer and the first polarizer,
the second substrate is disposed between the liquid crystal layer and the second polarizer, and
an angle between an arrangement direction of the first electrode and the second electrode and an absorption axis of each of the first polarizer and the second polarizer is equal to or less than 10 degrees.

13. The privacy device according to claim 1, wherein in a cross-sectional view, a pitch between the first electrode and the second electrode is 5 μm to 20 μm.

14. The privacy device according to claim 1, wherein in a cross-sectional view, a ratio between a line width of each of the first electrode and the second electrode and a space between the first electrode and the second electrode is 2:8 to 8:2.

15. The privacy device according to claim 1, wherein in a top view, shapes of the first electrode and the second electrode are respectively linear, sawtooth, wedge-shaped, or a combination of at least two of the above.

16. The privacy device according to claim 1, wherein an angle between an extension direction of the first electrode or the second electrode and a direction perpendicular to an arrangement direction of the first electrode and the second electrode is equal to or less than 30 degrees.

17. The privacy device according to claim 1, further comprising:
a backlight module disposed under the display panel and comprising a light control film, wherein the light control film comprises a plurality of opaque structures arranged in an arrangement direction of the first electrode and the second electrode.

18. The privacy device according to claim 17, wherein the switchable privacy panel is disposed between the display panel and the backlight module.

19. A privacy device comprising a share mode and a privacy mode, and the privacy device comprising:
a display panel; and
a switchable privacy panel overlapped with the display panel, wherein:
in response to the privacy device being switched to the share mode, the switchable privacy panel is switched to a diffusion mode to diffuse incident light, and
in response to the privacy device being switched to the privacy mode, the switchable privacy panel is switched to an absorption mode to absorb a portion of incident light.

20. The privacy device according to claim 19, wherein the switchable privacy panel is color filter free.
